(19) United States
(12) Patent Application Publication
(10) Pub. No.: US 2026/0192830 A1
(43) Pub. Date: Jul. 9, 2026

(54) COLLISION AVOIDANCE SYSTEM

(71) Applicant: TOYOTA JIDOSHA KABUSHIKI KAISHA, Toyota-shi (JP)

(72) Inventors: MATTHEW J. BROWN, Palo Alto, CA (US); Zhaoyuan Huo, Palo Alto, CA (US); Julia Pralle, Palo Alto, CA (US); Sarah M. Koehler, San Jose, CA (US); Carrie G. Bobier-Tiu, Sunnyvale, CA (US)

(73) Assignee: TOYOTA JIDOSHA KABUSHIKI KAISHA, Toyota-shi (JP)

(21) Appl. No.: 19/012,356

(22) Filed: Jan. 7, 2025

(51) Int. Cl. B60W 60/00; B60W 30/09; B60W 30/095; B60W 50/00

(52) U.S. Cl. CPC B60W 60/0059; B60W 30/09; B60W 30/0953; B60W 30/0956; B60W 50/0097; B60W 60/0015; B60W 60/0027; B60W 60/0053; B60W 2554/806; B60W 2556/10

(57) ABSTRACT

A system includes sensors that obtain sensor data of an ego vehicle and of an obstacle during operation of the ego vehicle. The system includes one or more processors, and a memory storing instructions that, when executed by the one or more processors, cause the system to perform operations. The operations include inferring one or more categories of the obstacle based on the sensor data, based on the inferred one or more categories, selecting one or more prediction models, determining any possibility of a collision between the ego vehicle and the obstacle based on the one or more selected prediction models and the navigation characteristics, and based on the determination of any possibility of a collision, selectively performing one or more actions to avoid or mitigate a possible collision.

### TECHNICAL FIELD

The present disclosure relates generally to assessing a possibility of a collision involving an ego vehicle and implementing measures to avoid or mitigate a potential collision.

### DESCRIPTION OF RELATED ART

By 2040, an anticipated 75 percent of vehicles will be autonomous or semi-autonomous, according to the Institute of Electrical and Electronics Engineers (IEEE). Safety of autonomous vehicles remains a paramount concern. According to current estimates from 2020 or 2021, approximately 9.1 autonomous or semi-autonomous vehicle crashes occur per million miles driven. Some safety features of autonomous vehicles include lane departure warning systems. However, current safety features do not adequately provide safety for autonomous vehicles.

### BRIEF SUMMARY OF THE DISCLOSURE

According to various embodiments of the disclosed technology, a system comprises one or more sensors configured to configured to obtain sensor data of an ego vehicle and of an obstacle during operation of the ego vehicle, the sensor data comprising navigation characteristics of the ego vehicle and the obstacle; and one or more processors. The system comprises a memory storing instructions that, when executed by the one or more processors, cause the system to perform operations. The operations include inferring one or more categories of the obstacle based on the sensor data; based on the inferred one or more categories, selecting one or more prediction models, wherein each of the one or more prediction models output reachability parameters corresponding to different navigation characteristic inputs, wherein each of the reachability parameters are indicative of any possibility of a collision between the ego vehicle and the obstacle; determining any possibility of a collision between the ego vehicle and the obstacle based on the one or more selected prediction models and the navigation characteristics; and based on the determination of any possibility of a collision, selectively performing one or more actions to avoid or mitigate a possible collision.

In some embodiments, the navigation characteristics comprising any of a relative position, a relative velocity, and a relative heading of the ego vehicle with respect to the obstacle.

In some embodiments, the navigation characteristics comprise a relative acceleration of the ego vehicle with respect to the obstacle.

In some embodiments, the obstacle comprises another vehicle or a pedestrian.

In some embodiments, the one or more actions comprise performing a disengagement in response to the outputted indication indicating a possibility of a collision, the disengagement comprising switching the ego vehicle at least partially from an autonomous mode to a manual mode.

In some embodiments, the one or more actions comprise engaging the ego vehicle.

In some embodiments, the sensor data comprises time-series data indicative of historical velocities of the obstacle.

In some embodiments, the sensor data comprises historical behavior characteristics of the obstacle, and the inferring of the category comprises inferring a degree of aggressiveness or a degree of erraticism of a behavior of the obstacle based on the historical behavior characteristics.

In some embodiments, the performing of the one or more actions comprises displaying, on a screen within an interior of the ego vehicle, a heat map indicative of a potential collision region.

In some embodiments, the prediction models output reachability parameters based on an assumption of an extreme behavior scenario of the obstacle, the extreme behavior scenario comprising the obstacle performing an action that is most likely to cause a collision within constraints of a corresponding prediction model.

In some embodiments, the prediction models output reachability parameters based on an assumption of a response by the ego vehicle to the action of the obstacle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3A illustrates an example architecture for detecting a potential collision for a navigating ego vehicle and alerting in response to the detection, in accordance with one embodiment of the systems and methods described herein.

FIG. 3B illustrates an example implementation of a storage system, in accordance with one embodiment of the systems and methods described herein.

FIGS. 4A-4C illustrate example implementations of detecting a potential collision for a navigating ego vehicle and alerting in response to such detection, in accordance with one embodiment of the systems and methods described herein, which may be implemented in conjunction with the example architecture illustrated in FIG. 3.

FIG. 5 is an example computing component that may be used to implement various features of embodiments described in the present disclosure.

The figures are not exhaustive and do not limit the present disclosure to the precise form disclosed.

### DETAILED DESCRIPTION

A collision avoidance system of an ego vehicle obtains sensor data from one or more sensors. The collision avoidance system may operate when the vehicle is in either autonomous mode or manual mode. The sensor data may include characteristics of an obstacle, which may include a pedestrian, another vehicle, or a stationary obstacle. The characteristics may include time-series data indicative of navigation characteristics, such as position, velocity, heading, and/or acceleration. In some embodiments, the sensor data may include characteristics of the ego vehicle itself.

Based on the sensor data, the collision avoidance system first assesses a possibility of a collision between the ego vehicle and the obstacle by performing a reachability analysis. The collision avoidance system may infer one of more categories of the obstacle based on the sensor data of the obstacle. Example categories may include behavioral categories, such as passive, normal, or aggressive. Other example categories may include typical and erratic, which has a larger range of permitted steering or movement compared to typical. Each of, or a combination of, the categories may correspond to a prediction model of the obstacle. For example, separate prediction models may exist for a passively behaving obstacle, a normally behaving obstacle, and an aggressively behaving obstacle. Each prediction model may have inputs of the navigation characteristics such as a relative position, relative velocity, and relative heading of the ego vehicle with respect to the obstacle. Each prediction model may be associated with constraints that define behaviors or behavioral limits corresponding to a given category of obstacle. Each prediction model may output an indicator of whether a collision between the ego vehicle and the obstacle is possible. In some embodiments, to predict whether a collision is possible, each prediction model generates an output under an assumption of an extreme behavioral scenario of the obstacle. In the extreme behavioral scenario, the obstacle acts in a manner that has a highest likelihood of causing a collision with the ego vehicle, within the constraints of the prediction model. Under this assumption, each prediction model determines whether or not the ego vehicle has an actuation capability, capacity, or ability to avoid a collision.

Once the collision avoidance system infers one of more categories of the obstacle, the collision avoidance system assesses whether or not a collision is possible based on one or more corresponding prediction models. Upon determining that a collision is possible, the collision avoidance system may implement certain actions to avoid a collision, or mitigate a collision (e.g., reduce a possibility of a collision, or mitigate a severity of a collision). These actions may include displaying a warning on a screen within an interior of the ego vehicle, performing a disengagement, or implementing an actuation to move away from the potential collision region. For example, displaying a warning on a screen includes displaying a potential collision region. As another example, performing a disengagement may include switching a mode of the ego vehicle, such as from an autonomous mode to a manual mode or a partially autonomous mode.

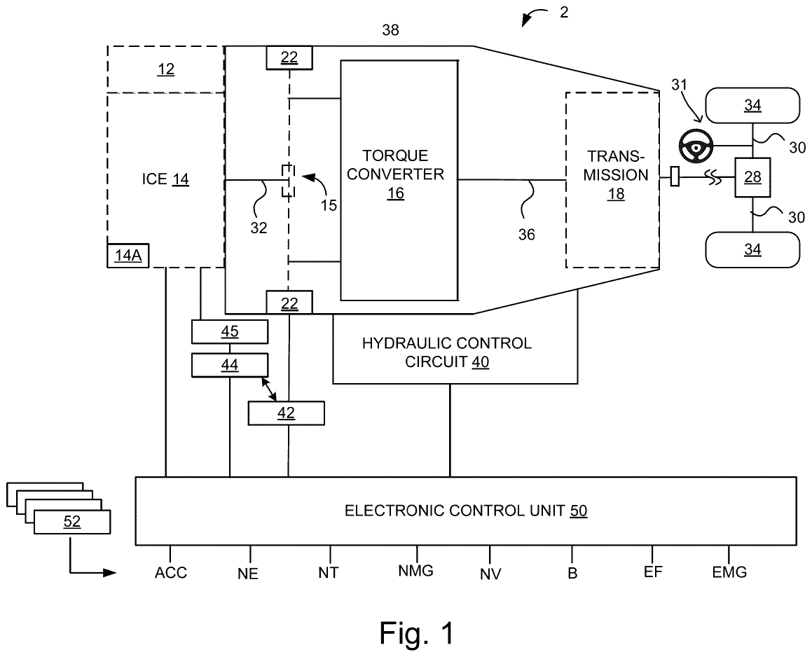

The systems and methods disclosed herein may be implemented with any of a number of different ego vehicles and ego vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for driver fitness assessment can be implemented in other types of ego vehicles including gasoline- or diesel-powered vehicles, fuel-cell vehicles, electric vehicles, or other vehicles.

FIG. 1 illustrates a drive system of an ego vehicle 2 that may include an internal combustion engine 14 and one or more motors 22 (e.g., electric motors, which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30. The ego vehicle 2 may include a steering system 31. The steering system 31 may be implemented via electronic power steering (EPS) or steer-by-wire.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and braking. As a more particular example, output torque of the motor 22 can be increased or decreased by electronic control unit 50 through the inverter 42. In some embodiments, the electronic control unit 50 may control the steering system 31.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to electronic control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. In some embodiments, sensors 52 may detect navigation characteristics of the ego vehicle 2 or of an obstacle, such as another vehicle, pedestrian, animal, or other obstacle. Here, navigation characteristics may include an absolute position, an absolute velocity, an absolute heading, or an absolute acceleration of the ego vehicle 2 or of the obstacle. The navigation characteristics may also include a relative position, a relative velocity, a relative heading, or a relative acceleration of the ego vehicle 2 with respect to the obstacle.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

As evident, sensors 52 may be included to detect not only vehicle conditions but also to detect external conditions, such as of the obstacle, as well. Sensors that might be used to detect external conditions can include, for example, sonar, radar, lidar or other vehicle proximity sensors, and cameras or other image sensors. Image sensors can be used to detect, for example, objects such as traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 52 may be within an interior or on an exterior of the ego vehicle 2. The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

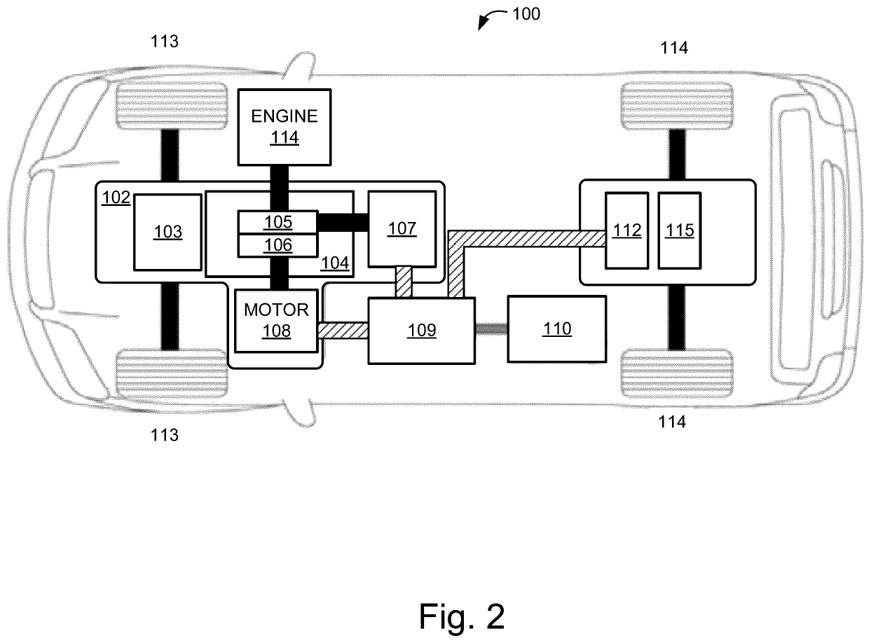

FIG. 2 is another example of an ego vehicle with which systems and methods for assessing occupant fitness can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. One of ordinary skill in the art reading this description will understand how the disclosed embodiments can be implemented with vehicle platforms.

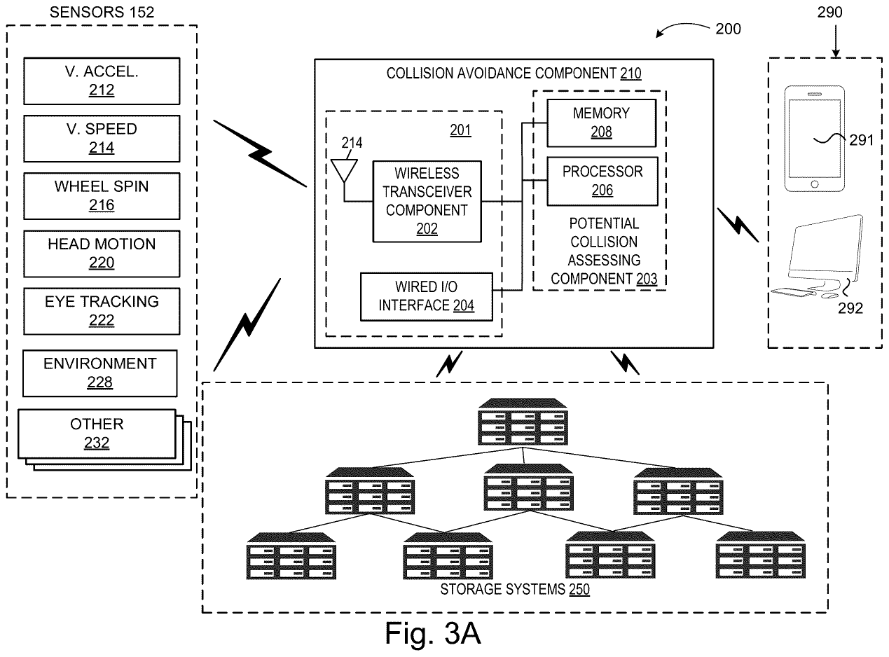

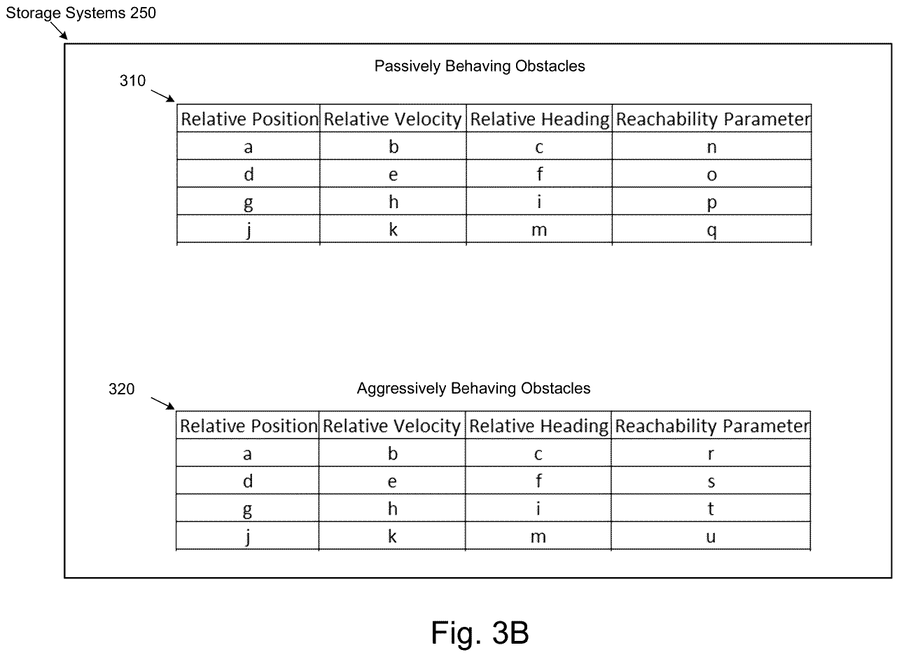

FIG. 3A illustrates an example architecture for adaptively and selectively avoiding or mitigating a collision, based on sensor data detected at least in part by sensors 52 illustrated in FIG. 1, in accordance with one embodiment of the systems and methods described herein. Referring now to FIG. 3A, in this example, collision avoidance system 200 includes a collision avoidance component 210, which selectively activates or deactivates certain features of the ego vehicle 2, implements other actions of the ego vehicle 2 or actions directed towards or controlling an obstacle. These other actions may include displaying a warning of a potential collision, and/or engaging or disengaging the ego vehicle 2, to avoid or mitigate a potential collision. Collision avoidance component 210 can be implemented as an ECU or as part of an ECU such as, for example electronic control unit 50. In other embodiments, collision avoidance component 210 can be implemented independently of the ECU. Collision avoidance component 210 in this example includes a communication component 201, and a potential collision assessing component 203 (including a processor 206 and memory 208 in this example). Components of collision avoidance component 210 are illustrated as communicating with each other via a data bus, although other communication in interfaces can be included.

The collision avoidance system 200 may include a plurality of sensors 152, one or more storage systems 250 which may include remote servers, and one or more other devices 290 which may be external to or internally located within the ego vehicle 2. In some embodiments, the one or more other devices 290 include one or more different computing or mobiles devices 291 and 292, and may be configured to receive a subset (e.g., a portion or all of) outputs from the collision avoidance component 210, either in real-time or in a delayed manner via V2N communication. Sensors 152, storage systems 250, and one or more other devices 290 can communicate with the collision avoidance component 210 via a wired or wireless communication interface. Although sensors 152, storage systems 250 and one or more other devices 290 are depicted as communicating with collision avoidance component 210, they can also communicate with each other as well as with other vehicle systems. In some embodiments, the one or more other devices 290 include one or more different computing or mobiles devices 291 and 292, and may be configured to receive a subset (e.g., a portion or all of) outputs from the collision avoidance component 210, either in real-time or in a delayed manner via V2N communication.

The potential collision assessing component 203 assesses whether a collision between the ego vehicle 2 and an obstacle is possible, based on a reachability analysis such as a Hamilton-Jacobi reachability analysis. Based on the assessment of whether a collision is possible, the collision avoidance component 210 selectively implements an action to avoid or mitigate a collision. To assess whether a collision is possible, the potential collision assessing component 203 infers one or more categories or characterizations (hereinafter “categories”) of an obstacle based on sensor data of the obstacle. In some embodiments, the categories may indicate a type of behavior or navigation manner of the obstacle. The potential collision assessing component 203 may infer one or more categories based on historical velocity data, acceleration data, historical behavioral data such as navigation behaviors of the obstacle, and/or based on a type of the obstacle. For example, if an obstacle is an authority vehicle (e.g., an ambulance or police vehicle), the potential collision assessing component 203 may infer that the authority vehicle should be categorized as an aggressively behaving obstacle. In other examples, if an obstacle is another vehicle, and historical velocity data indicates that the other vehicle drives faster than surrounding traffic, the potential collision assessing component 203 may infer that the other vehicle should be categorized as an aggressively behaving obstacle. In other examples, if historically, another vehicle frequently changes lane, overtakes vehicles, and/or executes dangerous maneuvers, then the potential collision assessing component 203 may infer that the other vehicle should be categorized as an aggressively behaving obstacle.

The potential collision assessing component 203 selects one or more particular prediction models corresponding to the one or more inferred categories of the obstacle. For example, the potential collision assessing component 203, upon inferring that the obstacle is categorized as an aggressively behaving obstacle, may select a particular prediction model corresponding to an aggressively behaving obstacle. On the other hand, if the potential collision assessing component 203 infers that the obstacle is characterized as a passively behaving obstacle, the potential collision assessing component 203 may select a particular prediction model corresponding to a passively behaving obstacle.

The prediction models may be based on dynamics and/or kinematics of the obstacle and of the ego vehicle 2. Each of the prediction models may receive inputs of navigation characteristics, such as a relative position of the ego vehicle 2, a relative velocity of the ego vehicle 2, and a relative heading of the ego vehicle 2 with respect to an obstacle. In some embodiments, the navigation characteristics may be represented by a relative state between the ego vehicle 2 and an obstacle. The relative state may be represented as x∈ [symbol] . In some embodiments, a relative dynamics model may be represented as a derivative of the relative state, \dot{x}=f(x, [symbol] , [symbol] ), in which [symbol] ∈ [symbol] ⊂ [symbol] represent bounded inputs of the ego vehicle 2, and [symbol] ∈ [symbol] ⊂ [symbol] represent bounded inputs of the obstacle. The derivative of the relative state may represent joint dynamics between the ego vehicle 2 and an obstacle.

Given a lateral kinematics model, the relative state may be represented as

$$x = [ \begin{matrix}{x}_{rel} \\ {𝓎}_{rel} \\ {ψ}_{rel}\end{matrix} ] ,$$

which include a relative x-position of the ego vehicle 2 with respect to the obstacle, a relative y-position of the ego vehicle 2 with respect to the obstacle, and a relative heading of the ego vehicle 2 with respect to the obstacle. In some embodiments, within a lateral kinematics model, the derivative of the relative state may be represented as

$$\dot{𝓍} = [ \begin{matrix}- {υ}_{a} + {υ}_{e} cos {ψ}_{rel} + {𝓊}_{a} \cdot {𝓎}_{rel} \\ {υ}_{e} sin {ψ}_{rel} - {𝓊}_{a} \cdot {𝓍}_{rel} \\ {𝓊}_{e} - {𝓊}_{a}\end{matrix} ] .$$

In some embodiments, the navigation characteristics may include a relative acceleration of the ego vehicle 2 with respect to an obstacle, and/or higher order derivatives of the relative acceleration. Given a set of navigation characteristics, each of the prediction models may output an indication of whether or not a collision is possible between the ego vehicle 2 and the obstacle, and/or a severity of a collision. Different prediction models may have different outputs corresponding to a same set of inputs. For example, a prediction model corresponding to an aggressively behaving obstacle may have a different output compared to a prediction model corresponding to a passively behaving obstacle.

In some embodiments, to predict whether a future collision is possible, a prediction model generates an output under an assumption of an extreme behavioral scenario of the obstacle. In the extreme behavioral scenario, the obstacle is assumed to act in a manner that has a highest likelihood of causing a collision with the ego vehicle 2, within the constraints of the prediction model for the given category. An extreme behavioral scenario may be different for different prediction models. For example, an extreme behavioral scenario may include another vehicle travelling at 5 miles per hour above a speed limit, limited turning angle for a steering wheel, and limited lane changing if the other vehicle is categorized as a passively behaving vehicle. On the other hand, an extreme behavioral scenario may include another vehicle travelling at 30 miles per hour above a speed limit, higher turning angle for a steering wheel, and frequent lane changing if the other vehicle is categorized as an aggressively behaving vehicle. In some embodiments, the prediction model also assumes that the ego vehicle 2 acts in a manner to counteract a behavior of the obstacle, such as a most effective reaction to counteract the extreme behavioral scenario, given dynamic and/or kinematic constraints of the ego vehicle 2. Using the aforementioned assumptions, the prediction model outputs an indication of whether a collision would occur, assuming the extreme behavioral scenario of the obstacle and a most effective reaction of the ego vehicle 2. In some embodiments, the prediction model, or a separate model, outputs a probability of a collision.

In some embodiments, the output of the indication may be manifested as a reachability parameter. The reachability parameter may indicate a distance that the ego vehicle 2 maintains from the obstacle, assuming the extreme behavioral scenario of the obstacle, and assuming the most effective reaction. A zero value of the reachability parameter may indicate that a collision is possible. In some embodiments, the reachability parameter may indicate a predicted severity of a collision.

In some embodiments, the output of the indication may be represented as A(t)={x:V(t,x)≤0}, and in which A(0) is a set of relative states that represent collision. A(t) may be computed as a backwards reachable tube (BRT), as a set of states for which collision is unavoidable under the extreme behavioral scenario for the obstacle, no matter what reactions the ego vehicle 2 takes. In some embodiments, V represents a function in which a collision is possible. In some embodiments, V is a signed distance between the ego vehicle 2 and an obstacle. V(t,x) represents a function that indicates how close the obstacle approaches the ego vehicle 2 within a duration of time t and starting from relative state x, if the obstacle tries to minimize V and the ego vehicle 2 tries to maximize V. In some embodiments, V is the solution to the Hamilton-Jacobi-Isaacs PDE, with boundary condition V₀ as follows:

$$\begin{matrix}min \\ s ∈ [ t , 0 ]\end{matrix} \frac{\partial V ( s , x )}{\partial s} + H ( s , ∇ V ( s , x ) ) = 0$$

$$V ( 0 , x ) = {V}_{0} ( x )$$

$$H ( t , ∇ V ( t , x ) ) = \begin{matrix}max \\ {𝓊}_{ℯ}\end{matrix} \begin{matrix}min \\ {𝓊}_{𝒶}\end{matrix} ∇ V ( t , x ) . \int ( x , {𝓊}_{ℯ} , {𝓊}_{𝒶} )$$

$${𝓊}_{𝒶}^{*} = arg \begin{matrix}min \\ {𝓊}_{𝒶}\end{matrix} ∇ V ( t , x ) \cdot \int ( x , {𝓊}_{ℯ} , {𝓊}_{𝒶} )$$

$${𝓊}_{ℯ}^{*} = arg \begin{matrix}max \\ {𝓊}_{ℯ}\end{matrix} \begin{matrix}min \\ {𝓊}_{𝒶}\end{matrix} ∇ V ( t , x ) \cdot \int ( x , {𝓊}_{ℯ} , {𝓊}_{𝒶} )$$

$${𝓊}_{𝒶}^{*} = arg \begin{matrix}min \\ {𝓊}_{𝒶} ϵ [ {𝒶}_{min} , {𝒶}_{max} ]\end{matrix} ∇ V [ 0 ] \cdot {\dot{𝓍}}_{rel} + ∇ V [ 1 ] \cdot {\dot{𝓎}}_{rel} + ∇ V [ 2 ] \cdot {\dot{ψ}}_{rel}$$

Under an assumption of a lateral kinematic model, this expression is linear in [symbol] and [symbol] as follows:

$$\begin{matrix}s = \frac{\partial }{\partial {𝓊}_{𝒶}} ( ∇ V [ 0 ] \cdot {\dot{𝓍}}_{r e l} + … ) \\ = ∇ V [ 0 ] \cdot {𝓎}_{rel} - ∇ V [ 1 ] \cdot {𝓍}_{rel} - ∇ V [ 2 ]\end{matrix}$$

$$if ( s < 0 ) :$$

$$u\_a = a\_max$$

$$else :$$

$$u\_a = a\_min$$

Here, V(0, x) defines the function at a time of collision,

$${𝓊}_{ℯ}^{*}$$

represents an optimal input of the ego vehicle as a function of ∇V and x, and

$${𝓊}_{𝒶}^{*}$$

represents an optimal input of the obstacle as a function of ∇V and x.

In some embodiments, the reachability analysis may be performed offline and/or online. In some embodiments, whether the reachability analysis is to be performed at least partially offline depends on a degree of computational complexity and/or an availability of online computing resources or onboard computing power within the collision avoidance system 200 and/or other onboard computing processors. In some embodiments, if the reachability analysis is performed at least partially offline, the potential collision assessing component 203 may offload at least part of the reachability analysis to a separate computing server or computing system.

As illustrated in FIG. 3B, prediction model data 310, 320, including outputs and inputs of different prediction models, may be stored in storage systems 250. Storage systems 250 may include one or more remote servers. The prediction model data 310, 320 may be stored in a structured format, such as a tabular format (e.g., a lookup table). For example, the prediction model data 310, 320 may include an output of reachability parameters corresponding to a set of navigation characteristic inputs for different categories of obstacles, such as passively behaving obstacles and aggressively behaving obstacles. The navigation characteristic inputs include a relative position of the ego vehicle 2, a relative velocity of the ego vehicle 2, and a relative heading of the ego vehicle 2 with respect to an obstacle.

Returning to FIG. 3A, sensors 152 can include, for example, sensors 52 such as those described above with reference to the example of FIG. 1. Sensors 152 can include additional sensors. In the illustrated example, sensors 152 may obtain navigation characteristics and/or other related data such as behavioral and/or interaction data of one or more obstacles external to the ego vehicle 2, and/or of occupants within the ego vehicle 2. The sensors 152 may include vehicle acceleration sensors 212, vehicle speed sensors 214, wheelspin sensors 216 (e.g., one for each road wheel), head motion sensors 220 to detect rotational and/or translational motion of a head of a driver within the ego vehicle 2, eye tracking sensors 222 to detect eye movements of the driver, and environmental sensors 228 (e.g., to detect traffic density, speed of surrounding traffic, weather, air quality, and/or other environmental conditions). In some embodiments, sensor data from the environmental sensors 228 may affect whether or not an output from the collision avoidance component 210 is to be displayed, and/or whether certain actions are to be implemented by the collision avoidance component 210. For example, if traffic density is high and/or the environment has hazy conditions, then certain actions may be less or more likely to be implemented. Additional sensors 232 can also be included as may be appropriate for a given implementation of collision avoidance system 200. The sensors 152 may be configured to detect and/or alert for any indications of anomalous behavior, as will be described below.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to perform a driver fitness test, for processor 206 as well as any other suitable information. Memory 208 can be made up of one or more modules of one or more different types of memory, and may be configured to store data and other information as well as operational instructions that may be used by the processor 206.

Although the example of FIG. 3A is illustrated using processor and memory components, as described below with reference to components disclosed herein, potential collision detecting component 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up collision detecting component 203 and/or collision avoidance component 210.

Communication component 201 includes either or both a wireless transceiver component 202 with an associated antenna 205 and a wired I/O interface 204 with an associated hardwired data port (not illustrated). As this example illustrates, communications with collision avoidance component 210 can include either or both wired and wireless communication components 201. Wireless transceiver component 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by collision avoidance component 210 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

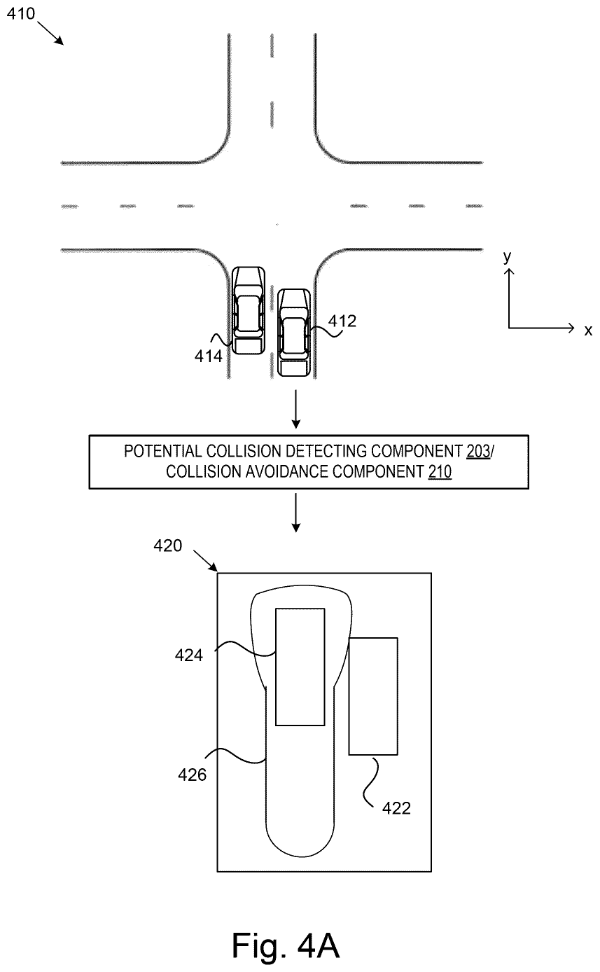

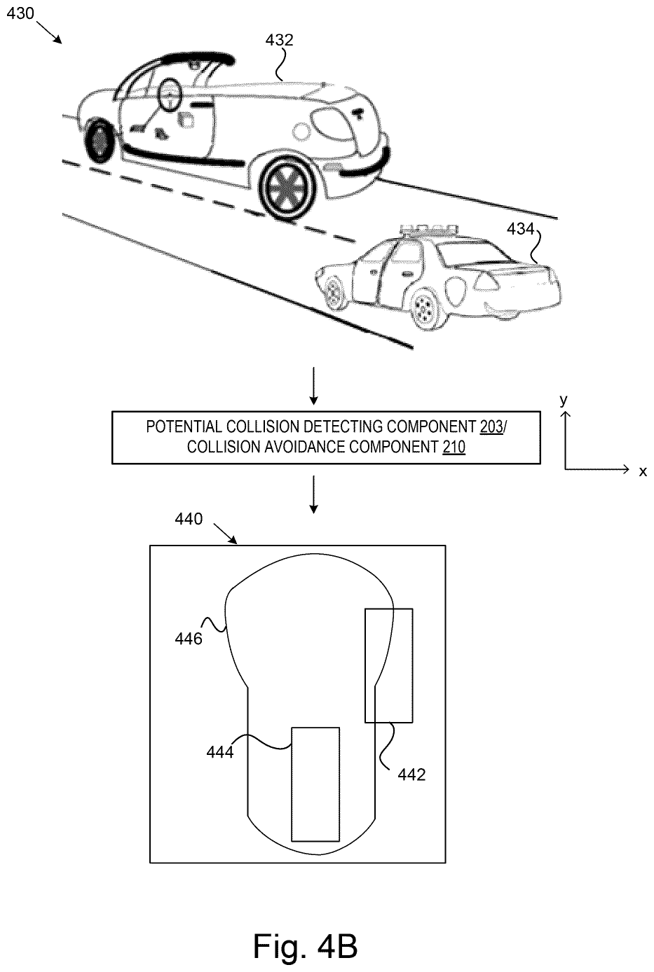

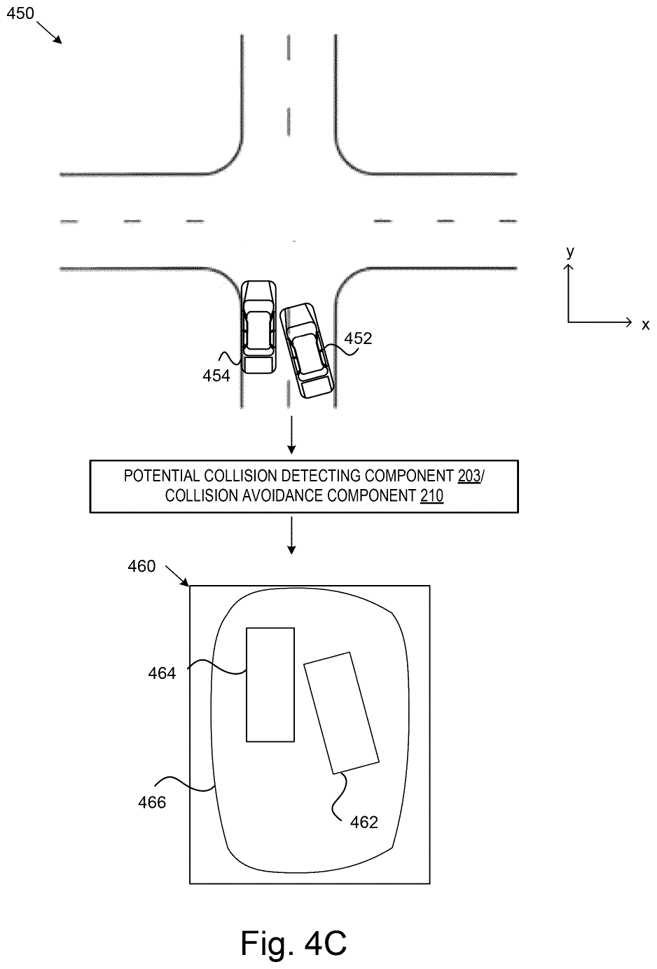

FIGS. 4A-4C illustrate embodiments of the potential collision assessing component 203 and the collision avoidance component 210. In some embodiments, as illustrated in FIGS. 4A-4C, the potential collision assessing component 203 computes potential collision regions according to a backward reachable tube (BRT) under certain assumptions for simplicity. In some embodiments, the principles in FIGS. 4A-4C may be applied in conjunction with FIG. 3. FIG. 4A illustrates an operation scenario 410 of an ego vehicle 412 and an obstacle 414 (e.g., another vehicle). In some embodiments, the ego vehicle 412 may be implemented as the ego vehicle 2. Sensor data of the obstacle 414 and of the ego vehicle 412, including navigation characteristics (e.g., relative position in x and y coordinates, relative velocity in x and y coordinates, and relative heading of the ego vehicle 412 relative to the obstacle 414), are ingested into the potential collision detecting component 203. The potential collision detecting component 203 infers a category of the obstacle 414, such as an aggressively behaving obstacle, a passively behaving obstacle, or a normally behaving obstacle. Assume that the potential collision detecting component 203 infers that the category of the obstacle 414 is a normally behaving obstacle. The potential collision detecting component 203 obtains an indication of whether a collision is possible based on one or more applicable prediction models corresponding to the inferred categories and based on the relative velocities of the ego vehicle 412 with respect to the obstacle 414. Assume that the relative velocity of the ego vehicle 412 with respect to the obstacle 414 is approximately zero, meaning that the ego vehicle 412 has approximately a same absolute velocity as the obstacle 414. As previously alluded to, the prediction models may be based on assumptions that the obstacle 414 is operating under the extreme behavioral scenario and that the ego vehicle 412 is implementing a most effective response.

In some embodiments, if the potential collision detecting component 203 obtains an indication that a collision is possible, the collision avoidance component 210 may perform an action to avoid or mitigate a collision. For example, the collision avoidance component 210 may output a visualization 420 on a display screen within an interior of the ego vehicle 412, such as within an infotainment system of the ego vehicle 412. The visualization 420 may include a representation 422 of the ego vehicle 412, a representation 424 of the obstacle 414, and a potential collision region 426. In some embodiments, the potential collision region 426 indicates positions of the ego vehicle 412 in which a collision with the obstacle 414 is possible based on the applicable prediction models and the navigation characteristics. Here, the applicable prediction models may include a prediction model corresponding to a normally behaving obstacle. If the ego vehicle 412 is navigating within the potential collision region 426, then a collision is possible. In some embodiments, the potential collision region 426 may be computed as a backward reachable tube (BRT) encompassing a set of states that has a possibility of resulting in a collision within a future duration of time. In FIG. 4A, the relative heading between the ego vehicle 412 and the obstacle 414 may be assumed to be zero for simplicity. A nonzero relative heading would likely result in a different potential collision region. In some embodiments, the visualization 420 may correspond to or be similar to a heat map, in which the potential collision region 426 is a region to avoid for the ego vehicle 412.

FIG. 4B illustrates an operation scenario 430 of an ego vehicle 432 and an obstacle 434 (e.g., another vehicle). Compared to FIG. 4A, the obstacle 434 is illustrated as an authority vehicle and is categorized as a different category compared to the obstacle 414. In some embodiments, the ego vehicle 432 may be implemented as the ego vehicle 2. Sensor data of the obstacle 434 and of the ego vehicle 432, including navigation characteristics (e.g., relative position in x and y coordinates, relative velocity in x and y coordinates, and relative heading of the ego vehicle 432 relative to the obstacle 434), are ingested into the potential collision detecting component 203. The potential collision detecting component 203 infers a category of the obstacle 434, such as an aggressively behaving obstacle, a passively behaving obstacle, or a normally behaving obstacle. Assume that the potential collision detecting component 203 infers that a category of the obstacle 434 is an aggressively behaving obstacle because of a type of the obstacle 434 being an authority vehicle. The potential collision detecting component 203 obtains an indication of whether a collision is possible based on one or more of the applicable prediction models corresponding to an aggressively behaving obstacle. In some embodiments, the prediction models may be based on assumptions that the obstacle 434 is operating under the extreme behavioral scenario and that the ego vehicle 432 is implementing a most effective response.

In some embodiments, if the potential collision detecting component 203 obtains an indication that a collision is possible, the collision avoidance component 210 may perform an action to avoid or mitigate a collision. For example, the collision avoidance component 210 may output a visualization 440 on a display screen within an interior of the ego vehicle 432, such as within an infotainment system of the ego vehicle 432. The visualization 440 may include a representation 442 of the ego vehicle 432, a representation 444 of the obstacle 434, and a potential collision region 446. In some embodiments, the potential collision region 426 indicates positions of the ego vehicle 432 in which a collision with the obstacle 434 is possible based on the applicable prediction models and the navigation characteristics. Here, the applicable prediction models may include a prediction model corresponding to an aggressively behaving obstacle. If the ego vehicle 432 is navigating within the potential collision region 446, then a collision is possible. In some embodiments, the potential collision region 446 may be computed as a backward reachable tube (BRT) encompassing a set of states that has a possibility of resulting in a collision within a future duration of time. In FIG. 4B, the relative heading between the ego vehicle 432 and the obstacle 434 may be assumed to be zero for simplicity. A nonzero relative heading would likely result in a different potential collision region. An example with a nonzero relative heading is illustrated in FIG. 4C. Here, in FIG. 4B, the potential collision region 446 is larger compared to the potential collision region 426 due to the inference of the obstacle 434 being an aggressively behaving obstacle. In some embodiments, the potential collision region 446 may also depend on behaviors or inferred behaviors of the ego vehicle 432, such as a frequency of swerving of the ego vehicle 432.

FIG. 4C illustrates an operation scenario 450 of an ego vehicle 452 and an obstacle 454 (e.g., another vehicle). Compared to FIG. 4A and FIG. 4B, the ego vehicle 452 is illustrated as having a nonzero heading with respect to the obstacle 454 (e.g., not parallel to the obstacle 354). In some embodiments, the ego vehicle 452 may be implemented as the ego vehicle 2. Sensor data of the obstacle 454 and of the ego vehicle 452, including navigation characteristics (e.g., relative position in x and y coordinates, relative velocity in x and y coordinates, and relative heading of the ego vehicle 452 relative to the obstacle 454), are ingested into the potential collision detecting component 203. The potential collision detecting component 203 infers a category of the obstacle 454, such as an aggressively behaving obstacle, a passively behaving obstacle, or a normally behaving obstacle. Assume that the potential collision detecting component 203 infers that a category of the obstacle 454 is a normally behaving obstacle. The potential collision detecting component 203 obtains an indication of whether a collision is possible based on one or more of the applicable prediction models corresponding to a normally behaving obstacle. In some embodiments, the prediction models may be based on assumptions that the obstacle 454 is operating under the extreme behavioral scenario and that the ego vehicle 452 is implementing a most effective response.

In some embodiments, if the potential collision detecting component 203 obtains an indication that a collision is possible, the collision avoidance component 210 may perform an action to avoid or mitigate a collision. For example, the collision avoidance component 210 may output a visualization 460 on a display screen within an interior of the ego vehicle 452, such as within an infotainment system of the ego vehicle 452. The visualization 460 may include a representation 462 of the ego vehicle 452, a representation 464 of the obstacle 454, and a potential collision region 466. In some embodiments, the potential collision region 466 indicates positions of the ego vehicle 452 in which a collision with the obstacle 454 is possible based on the applicable prediction models and the navigation characteristics. Here, the applicable prediction models may include a prediction model corresponding to a normally behaving obstacle. If the ego vehicle 452 is navigating within the potential collision region 466, then a collision is possible. Here, in FIG. 4C, the potential collision region 466 is larger compared to the potential collision region 426 due to the nonzero heading of the ego vehicle 452 relative to the obstacle 454.

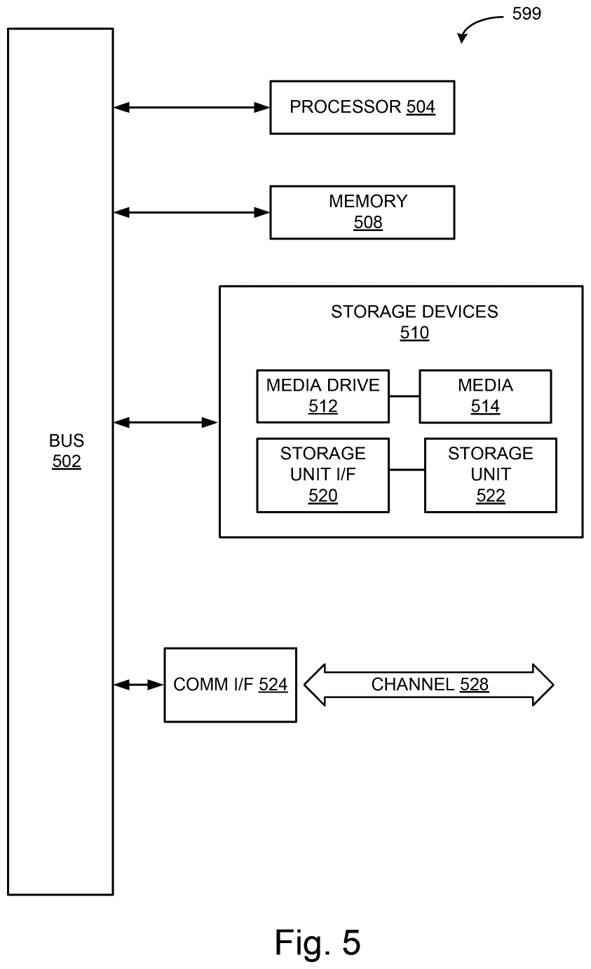

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to a “threshold” or “sufficiency” may be construed to encompass any applicable value or degree. For example, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity or degree may be construed as qualitatively satisfying some condition, such as presence of one or more common features. Any reference to sufficiently similar may also be construed to encompass same or similar meanings as satisfying a threshold.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
one or more sensors configured to obtain sensor data of an ego vehicle and of an obstacle during operation of the ego vehicle, the sensor data comprising navigation characteristics of the ego vehicle and the obstacle;
one or more processors;
a memory storing instructions that, when executed by the one or more processors, cause the system to perform:
inferring one or more categories of the obstacle based on the sensor data;
based on the inferred one or more categories, selecting one or more prediction models, wherein at least one of the one or more prediction models outputs a reachability parameter corresponding to a navigation characteristic input, wherein the reachability parameter is indicative of any possibility of a collision between the ego vehicle and the obstacle;
determining any possibility of a collision between the ego vehicle and the obstacle based on the one or more selected prediction models and the navigation characteristics; and
based on the determination of any possibility of a collision, selectively performing one or more actions to avoid or mitigate a possible collision.

2. The system of claim 1, wherein the navigation characteristics comprising any of a relative position, a relative velocity, and a relative heading of the ego vehicle with respect to the obstacle.

3. The system of claim 1, wherein the navigation characteristics comprise a relative acceleration of the ego vehicle with respect to the obstacle.

4. The system of claim 1, wherein each of the one or more prediction models output reachability parameters corresponding to different navigation characteristic inputs, and wherein each of the reachability parameters are indicative of a possibility of the collision between the ego vehicle and the obstacle.

5. The system of claim 1, wherein the one or more actions comprise an engagement or a disengagement in response to an outputted indication indicating a possibility of a collision, the disengagement comprising switching the ego vehicle at least partially from an autonomous mode to a manual mode.

6. The system of claim 1, wherein the sensor data comprises time-series data indicative of historical velocities of the obstacle.

7. The system of claim 1, wherein the sensor data comprises historical behavior characteristics of the obstacle, and the inferring of the category comprises inferring a degree of aggressiveness of a behavior of the obstacle based on the historical behavior characteristics.

8. The system of claim 1, wherein the performing of the one or more actions comprises displaying, on a screen within an interior of the ego vehicle, a heat map indicative of a potential collision region.

9. The system of claim 1, wherein the prediction models output reachability parameters based on an assumption of an extreme behavior scenario of the obstacle, the extreme behavior scenario comprising the obstacle performing an act that is most likely to cause a collision within constraints of a corresponding prediction model.

10. The system of claim 9, wherein the prediction models output reachability parameters based on an assumption of a response by the ego vehicle to the act of the obstacle.

11. A vehicle control system, comprising:
a processor; and
a memory coupled to the processor to store instructions, which when executed by the processor, cause the processor to perform operations, the operations comprising:
obtaining sensor data from one or more sensors, the sensor data comprising navigation characteristics of an ego vehicle and an obstacle;
inferring one or more categories of the obstacle based on the obtained sensor data;
based on the inferred one or more categories, selecting one or more prediction models, wherein at least one of the one or more prediction models outputs a reachability parameter corresponding to a navigation characteristic input, wherein the reachability parameter is indicative of any possibility of a collision between the ego vehicle and the obstacle;
determining any possibility of a collision between the ego vehicle and the obstacle based on the one or more selected prediction models and the navigation characteristics; and
based on the determination of any possibility of a collision, selectively performing one or more actions to avoid or mitigate a possible collision.

12. The vehicle control system of claim 11, wherein the navigation characteristics comprising any of a relative position, a relative velocity, and a relative heading of the ego vehicle with respect to the obstacle.

13. The vehicle control system of claim 11, wherein the navigation characteristics comprise a relative acceleration of the ego vehicle with respect to the obstacle.

14. The vehicle control system of claim 11, each of the one or more prediction models output reachability parameters corresponding to different navigation characteristic inputs, and wherein each of the reachability parameters are indicative of a possibility of the collision between the ego vehicle and the obstacle.

15. The vehicle control system of claim 11, wherein the one or more actions comprise an engagement or a disengagement in response to an outputted indication indicating a possibility of a collision, the disengagement comprising switching the ego vehicle at least partially from an autonomous mode to a manual mode.

16. The vehicle control system of claim 11, wherein the sensor data comprises time-series data indicative of historical velocities of the obstacle.

17. The vehicle control system of claim 11, wherein the sensor data comprises historical behavior characteristics of the obstacle, and the inferring of the category comprises inferring a degree of aggressiveness of a behavior of the obstacle based on the historical behavior characteristics.

18. The vehicle control system of claim 11, wherein the performing of the one or more actions comprises displaying, on a screen within an interior of the ego vehicle, a heat map indicative of a potential collision region.

19. The vehicle control system of claim 11, wherein the prediction models output reachability parameters based on an assumption of an extreme behavior scenario of the obstacle, the extreme behavior scenario comprising the obstacle performing an action that is most likely to cause a collision within constraints of a corresponding prediction model.

20. A non-transitory machine-readable medium having instructions stored therein, which when executed by a processor, cause the processor to perform operations, the operations comprising:
obtaining sensor data from one or more sensors, the sensor data comprising navigation characteristics of an ego vehicle and an obstacle;
inferring one or more categories of the obstacle based on the obtained sensor data;
based on the inferred one or more categories, selecting one or more prediction models, wherein each of the one or more prediction models output reachability parameters corresponding to different navigation characteristic inputs, wherein each of the reachability parameters are indicative of any possibility of a collision between the ego vehicle and the obstacle;
determining any possibility of a collision between the ego vehicle and the obstacle based on the one or more selected prediction models and the navigation characteristics; and
based on the determination of any possibility of a collision, selectively performing one or more actions to avoid or mitigate a possible collision.
